(19) United States
(12) Patent Application Publication
(10) Pub. No.: US 2014/0032313 A1
(43) Pub. Date: Jan. 30, 2014

(54) Online Consumer-Business Negotiation Tool and Software Product

(71) Applicants: Laura Fortner, Chatham, NJ (US); David Palmieri, Chatham, NJ (US)

(72) Inventors: Laura Fortner, Chatham, NJ (US); David Palmieri, Chatham, NJ (US)

(21) Appl. No.: 13/560,552

(22) Filed: Jul. 27, 2012

(51) Int. Cl. G06Q 30/02

(52) U.S. Cl. 705/14.49; 705/14.73

(57) ABSTRACT

The present invention includes a customization tool for online, automated consumer-business negotiation. The customization tool includes a valuation feature for assigning values to deal terms, whether they are inherently numeric, non-inherently numeric, or business-specific; a suggestion feature for allowing a consumer to suggest a set of deal terms; and a decision-algorithm feature for making a decision on behalf of the business concerning the consumer suggestion. The suggestion feature provides the consumer with every deal term over which the business has indicated a willingness to negotiate.

### FIELD OF THE INVENTION

The present invention relates to online marketing, and specifically to a tool for automating negotiations between consumers and businesses online.

### BACKGROUND

The internet has emerged as a powerful sales and marketing tool. As a simple example, purchases may be made by consumers from home. Advertisements may be emailed to potential consumers. Coupon codes may be used to automatically discount an online sale. Such simple transactions have matured into services such as those sold under the trademark GROUPON, where a deal is offered and if a certain number of people sign up for the deal, then the deal becomes available to all. An aspect that is missing from all of these examples is the ability for the consumer to negotiate deal terms with the business.

Certain products and services have been developed to create a virtual negotiation between the consumers and businesses. U.S. Pat. No. 6,338,050 to Conklin, for example, discloses a multivariate negotiations system that facilitates the creation of an online community of buyers and sellers, where the buyers and sellers may propose and negotiate orders and counteroffers with one another. Although this system allows for negotiation, the negotiation is not automated, and requires the buyers and sellers to personally review offers and counteroffers and respond to them. Negotiations therefore may take some time to complete.

In other systems, such as that disclosed in U.S. Pat. No. 7,203,662 to Das, negotiations are automated: A seller sets certain strategic policy rules that govern the making of operational business selling decisions. Purchasers are not privy to these strategic policy rules. A purchaser may elect to enter into negotiations to change the terms of an initial offer of sale. If the purchaser's suggested changes in terms align with the strategic policy rules set by the seller, then the purchase will be made per the purchaser's suggestion. Although this system allows for automated, real time negotiations if the purchaser happens to suggest changes aligned with the strategic policy rules, the purchaser is essentially making his or her counteroffers blindly. The purchaser has no idea what terms may be negotiable.

Therefore there is a need for an automated online negotiations tool where the purchaser has upfront knowledge of the negotiable terms.

### SUMMARY OF THE INVENTION

The present invention is a customization tool, negotiation tool, and software product for facilitating online, automated consumer-business negotiation. The present invention is executed online, through the internet, including mobile applications, between consumers and businesses. The term “business” should be construed broadly to encompass a range of businesses including, but not limited to, small merchants, business with any number of franchises, and large conglomerates.

In its most basic form, the customization tool of the present invention includes a valuation feature, a suggestion feature, and a decision-algorithm feature. The valuation feature assigns values to deal terms. The suggestion feature allows the consumer to suggest a set of deal terms to the business. The decision-algorithm feature makes a decision on behalf of the business concerning the consumer suggestion. The suggestion feature presents at least one deal term over which the business has previously indicated a willingness to negotiate. A deal term may be set and required as presented by the business as part of an acceptable set of deal terms, and is thus non-negotiable. A deal term may also be negotiable. At least one deal term in a set of deal terms is negotiable. For a “Sunday dine-in deal,” for example, the deal terms that the deal is for a Sunday and for dine-in only may be non-negotiable by the business, but other deal terms, such as percent discount on the meal may be negotiable. A negotiable deal term may include a number of deal term options, such as 20%, 30%, or 40% off. The suggestion feature presents these various deal terms to the consumer and allows the consumer to select deal terms and/or deal term options to form a suggested deal. This suggested deal is then evaluated by the decision-algorithm feature on behalf of the business. It is a key feature of the present invention that all possible deal terms are presented to the consumer up front. The consumer therefore knows that some combination of the possible deal terms presented to the consumer will result in a deal that is acceptable to the business. This is in comparison to some prior art where a business may be willing to negotiate a deal, but the consumer does not know what deal terms may be negotiable.

The valuation feature of the customization tool of the present invention assigns values to each deal term and deal term option. The valuation feature occurs before a consumer uses the suggestion feature, so that each possible deal term/option presented to the consumer has already been assigned a value. These values will be used in the decision-algorithm feature to determine whether a consumer suggested set of deal terms is acceptable or not, as described below. The valuation feature therefore assigns values to both non-negotiable deal terms and negotiable deal terms, as well as to each option within a negotiable deal term if the negotiable deal term includes options. A negotiable deal term with options, for example, such as a 10%, 20%, or 30% off of a sweater, will be valuated by the valuation feature as three different deal terms with different valuations for each. Therefore, every possible deal term/option is assigned a value, although only a subset of these deal terms will be included within a single deal. The various deal terms, whether negotiable or non-negotiable, and each option with a negotiable deal term that includes options, may be “gives” or “gets.” Gives are options the consumer is willing to give within the deal, or the benefit the business gets from the deal. Gets are options the consumer wants to receive within the deal, or the sacrifice the business must make from the deal. The valuation feature determines which deal terms are gives and which deal terms are gets. Valuation may be achieved by assigning a number to a deal term or option, but may also be achieved by using relative priority of the deal terms/options and/or desirability scales of the deal terms/options. One of ordinary skill in the art will recognize that there are several ways that deal terms and options may be valuated and each of these ways is contemplated as being within the scope of the present invention.

Importantly, the valuation feature is designed to assign values to deal terms and deal term options that may or may not be inherently numeric. Deal terms or options that are inherently numeric, and therefore fairly easy to valuate, include options such as price, percent discounts, or free items. Deal options that are non-inherently numeric, and therefore not as easily valuated, include repeat customer business, new customer referrals, or reserving the best table at a restaurant. In addition, the valuation feature utilizes business-specific valuations. Business-specific valuations may skew the valuation of a specific deal term or option based on the business's specific goals in presenting the deal. If a business is very eager to drum up more patronage on Sundays, for example, a deal term that the deal occurs on Sundays may have a valuation of a greater magnitude than a deal term that the deal occurs on Tuesdays. The decision-algorithm feature determines whether a consumer-suggested set of deal terms is acceptable. Once the suggestion feature has been executed, there is a consumer-suggested deal consisting of a set of deal terms/options. Hereinafter, “set” refers to this consumer-suggested set of deal terms and options that includes non-negotiable business-set deal terms, if any, in combination with the negotiable deal terms and options selected by the consumer. Each of these deal terms/options has been assigned a value by the valuation feature. The decision-algorithm feature applies these values to an algorithm and makes the determination as to whether or not the consumer-suggested set is acceptable. The decision-algorithm feature will not find a set of deal terms acceptable unless it includes at least one give and at least one get, as determined by the valuation feature. The preferred algorithm scores the gives of a set by combining the values of the gives of the set. It also scores the gets of a set by combining the values of the gets of the set. The combining may be by addition of the values or by other manipulation, such as in the case where the values are not necessarily numbers, but priorities, for example. The algorithm compares the give and get scores to determine acceptability of a set. The valuation feature and algorithm feature are therefore closely related: The valuation feature assigns values to the deal terms and decides whether the deal terms are gives or gets. The algorithm feature uses the values assigned by the valuation feature to determine acceptability of a set and will not find a set acceptable unless the set includes at least one give and at least one get, as determined by the valuation feature.

The customization tool is the key feature of the negotiation tool of the present invention. In its most basic form, the negotiation tool of the present invention includes a business presentation feature that lists at least one participating business and a deal term presentation feature for each of the listed businesses, where the deal term presentation feature presents at least one deal term offered by the listed business. At least one of the deal terms presented by the deal term presentation feature is negotiable. In the preferred embodiment of the deal term presentation feature, the deal terms are presented as discrete preset deals, which are a set of deal terms at least one of which is negotiable. In such embodiments, the deal term presentation feature allows the consumer to choose to accept a preset deal with a consumer preset deal acceptance feature, or to customize a preset deal with the customization feature, described in detail above. In another embodiment of the deal term presentation feature, a list of all deal terms, at least one of which is negotiable, on which a business has indicated a willingness to consider as part of a deal are presented. In such embodiments, the consumer must engage in some customization using the customization feature, by selecting which deal terms to include in his or her set, as well as what deal term options to include if the chosen deal terms include options.

The business presentation feature of the negotiation tool lists at least one participating business and includes the deal term presentation feature for each of the listed businesses. Participating businesses may be accessed in several ways. The consumer may search for a specific business by name; for a certain type of business, e.g. pizza restaurant; for businesses within a certain geography, e.g. by zip code; for businesses offering a certain deal term, e.g. a free appetizer; for businesses offering deals available now or within a specific time period; etc . . . One of ordinary skill in the art will recognize that there are many methods a consumer might search for a business interesting to the consumer for a variety of reasons, and each of these search methods is contemplated as being within the scope of the present invention. In addition, all participating businesses may be listed. Businesses sponsoring special deals for a specific time may be listed with the option for the consumer to search for other businesses. Moreover, the negotiation tool may identify and list businesses that are likely to be interesting to the consumer based on the consumer's past usage of the negotiation tool. There are many ways in which businesses may be presented to the consumer through the business presentation feature and each of these is contemplated as being within the scope of the present invention.

The reporting feature of the negotiation tool provides an automated report to the consumer whether or not the set is acceptable. Again this set of deal terms/options may include non-negotiable deal terms set by the business, as well as negotiable deal terms that the consumer selected or for which the consumer provided other input. The term “automated” should be considered to mean real-time or almost instantaneous. In other words, once a consumer submits a set for consideration, the reporting feature should supply the consumer with a decision as to whether or not the business will accept the set within seconds. As the world of possible deal terms/options, including those that are non-inherently numerical, have already been valuated by the valuation feature, the decision-algorithm feature is executed as soon as the consumer indicates he or she has prepared a desired set, so the decision on set acceptability to the business is automated.

The reporting feature preferably includes a non-acceptable options feature and an acceptable options feature. If it is determined that the set is non-acceptable, then the non-acceptable options feature presents the consumer with options to try to customize the deal again using the customization feature. In the preferred embodiment where the deal terms are presented as discrete deals, this option to customize again is offered as a choice to “Reset To Original” or “Customize It!” again. The option to “Reset To Original” changes the settings of any deal term options back to what they were in the preset deal. The option to “Customize It!” keeps the settings of any deal term options at the options that triggered the determination of non-acceptability for the set. Both of these options entail the use of the customization feature again. If it is determined that the set is acceptable, then the acceptable options feature presents the consumer with options to either accept the set and create a record of the set, or to further customize the set again using the customization feature. If the consumer chooses to further customize the set, the terms and options will begin at the options of the last accepted set, and the consumer may select different options from there to try to get an even better deal. If the consumer chooses to accept the set and create a record of the set, the record of the set is preferably a deal certificate that includes details relating to the business, the consumer, and the accepted set. Although the deal certificate may be physically printed out, it may also be accepted by some businesses electronically, such as on a smartphone or other device. Therefore it is preferred that although the decision as to whether a set is acceptable to the business is automated, as described above with reference to the reporting feature, the final decision as to whether or not the consumer will accept the set is not automated, and is determined by consumer action. In some embodiments of the customization feature, after the consumer has created a set, he or she may indicate that he or she will accept that set if it is accepted by the business as determined by the decision-algorithm feature. In such embodiments, if the decision-algorithm feature determines that the set is acceptable, the reporting feature will not present the consumer with acceptable options, but rather will present the consumer with the deal record directly.

Preferred embodiments of the negotiation tool also include business and consumer account features for creating business and consumer accounts, respectively, which allow businesses and consumers to provide information to the negotiation tool for storage and integration into the negotiation tool, as well as to monitor their history of use with the negotiation tool. The history may include preset deals, deal terms, and deal term options provided by the business; acceptable and non-acceptable sets created by the consumer; past deal certificates, and whether and when they were printed and/or redeemed. The business account feature allows for the entry of the information necessary for the negotiation tool to offer a preset deal from the business and provide deal terms/options for the consumer to customize. The business account feature may be executed by a representative of the negotiation tool communicating with the business and entering the information or by the business entering the information itself. As it is preferred that a deal certificate be specific to the particular consumer who suggested the acceptable set, it is preferred that consumers have a consumer account that stores at least basic information about the consumer, such as his or her name. The business and consumer account features include features to maintain the privacy of both the businesses and consumers. The preferred negotiation tool also includes a printing feature for printing out deal certificates, whether the deal certificates are the result of the consumer accepting the original preset deal or suggesting an ultimately accepted set through the customization feature.

In embodiments of the negotiation tool that include business and consumer accounts, the negotiation tool may also include a proactive business feature that allows businesses to approach consumers with deal offers. The proactive business feature may only be executable if a consumer has indicated his or her willingness to be approached within the consumer's account. Alternatively, the consumer's use of the negotiation tool may presuppose the consumer's acquiescence to being approached. The business may approach consumers based on criteria such as whether the consumer has dealt with similar businesses through the negotiation tool; whether the consumer is within a certain geographical region; whether the consumer has used the negotiation tool to make a deal within a certain time period; etc . . . Alternatively, the consumer may have expressed an interest in being approached by certain types of businesses and the businesses may proactively approach such customers. Whether or not the proactive business feature is available to a business using the negotiation tool may be a function of how much the business pays to be able to use the negotiation tool. The proactive business feature is yet another way in which a participating business may be presented to the consumer.

A specific example of the proactive business feature, the special offer feature, affects what deal terms are presented to the consumer by the deal term presentation feature. The special offer feature allows a business to present a special offer or special deal terms to a subset of consumers based on business criteria. The special offer feature allows a business to identify a type of consumer based on predefined parameters, such as demographic, behavioral, and historical, and provide a unique offer or deal term to such consumers, where that unique offer or deal term is not offered to all consumers that are not of that specific type. The special offer feature may be used by a business to promote its specific goals or to advantage a more desirable subset of consumers.

The preferred negotiation tool also includes a business deal tracking feature. The business deal tracking feature tracks aspects of the negotiation tool such as what sets consumers suggest, what sets consumers accept, what sets consumers print out, what sets are actually redeemed, time between set creation and redemption, etc . . . This information is available to businesses through their business accounts and may inform the businesses as to what deal terms are the most attractive, for example.

The negotiation software product of the present invention is storable on a computer readable medium and executable by a server, and includes sets of software code directly corresponding to the features of the negotiation tool of the present invention, as described above. One of ordinary skill in the art will recognize that the sets of software code of the negotiation software product of the present invention will create and execute the features of the negotiation tool of the present invention.

Therefore it is an aspect of the present invention to provide a customization tool for facilitating online, automated consumer negotiation.

It is a further aspect of the present invention to provide a customization tool that provides the consumer with negotiable terms on which the business has already indicated it is willing to negotiate.

It is a further aspect of the present invention to provide a customization tool that decides on behalf of the business whether a consumer suggested set of deal terms/options is acceptable by using a valuation feature that assigns values to both inherently numeric and non-inherently numeric terms and options.

It is a further aspect of the present invention to provide a customization tool that uses the values assigned by the valuation feature in an algorithm to determine the acceptability of a set of deal terms at least partially selected by a consumer.

It is a further aspect of the present invention to provide a negotiation tool for facilitating online, automated consumer negotiation including the customization tool of the present invention.

It is a further aspect of the present invention to provide a negotiation software product for facilitating online, automated consumer negotiation.

These aspects of the present invention are not meant to be exclusive and other features, aspects, and advantages of the present invention will be readily apparent to those of ordinary skill in the art when read in conjunction with the following description and accompanying drawings.

### BRIEF DESCRIPTION OF THE DRAWINGS

FIG. 1 is a block diagram showing the features of the negotiation tool and software product of the present invention.

FIG. 2 is a block diagram detailing the customization feature and software code of the present invention.

FIGS. 3A-3C are sample screenshots illustrating different versions of the business presentation feature and software code of the present invention.

FIGS. 4A and 4B are sample screenshots illustrating the preferred embodiment of the deal term presentation feature and software code of the present invention.

FIGS. 5A-5C are sample screenshots illustrating the suggestion feature and software code of the present invention.

FIGS. 6A and 6B are sample screenshots illustrating the acceptability and non-acceptability, respectively, of a set.

### DETAILED DESCRIPTION

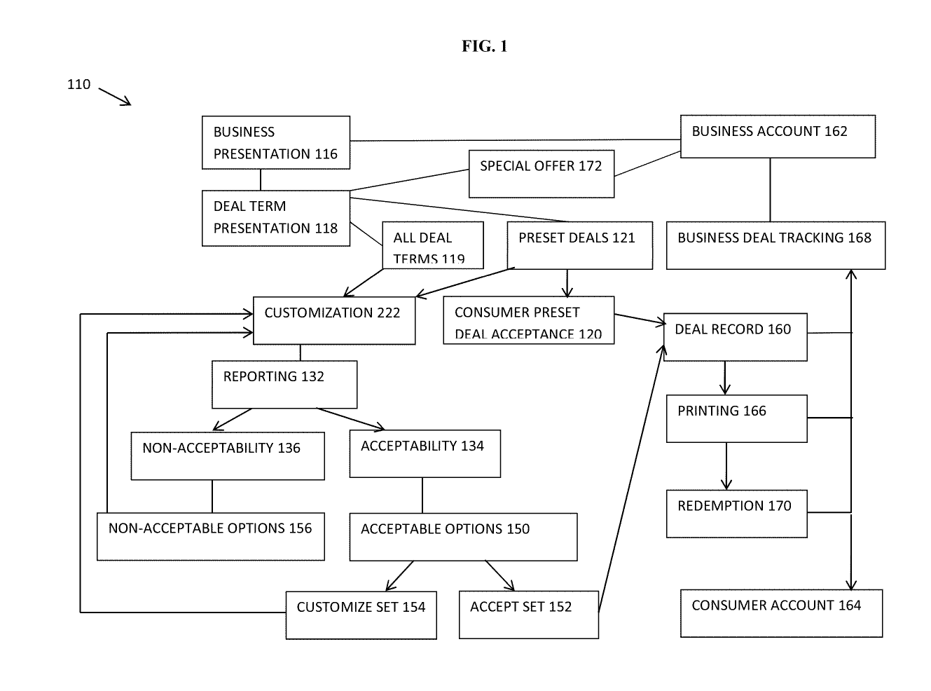

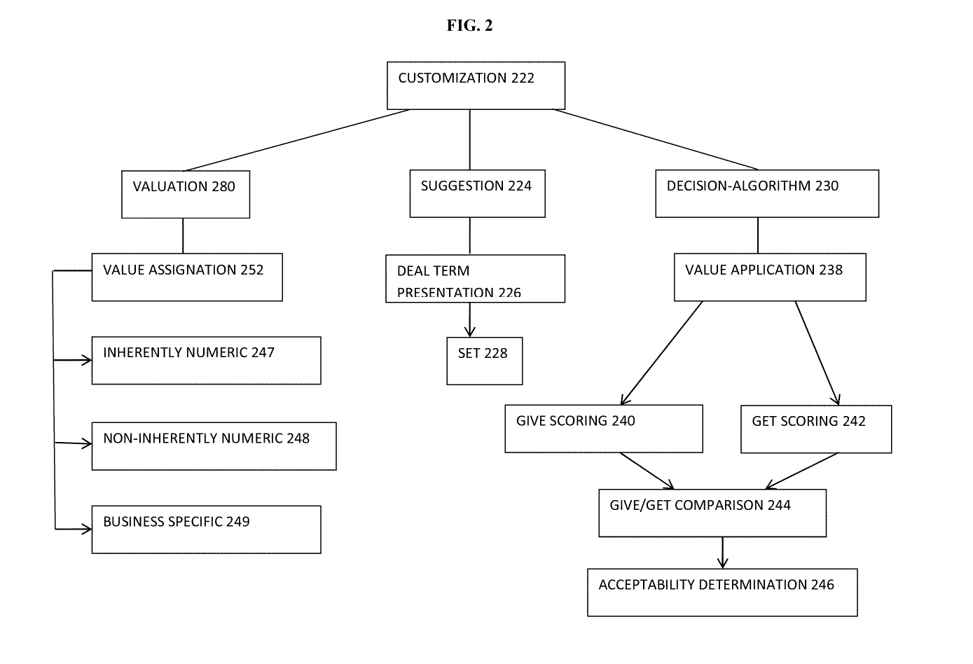

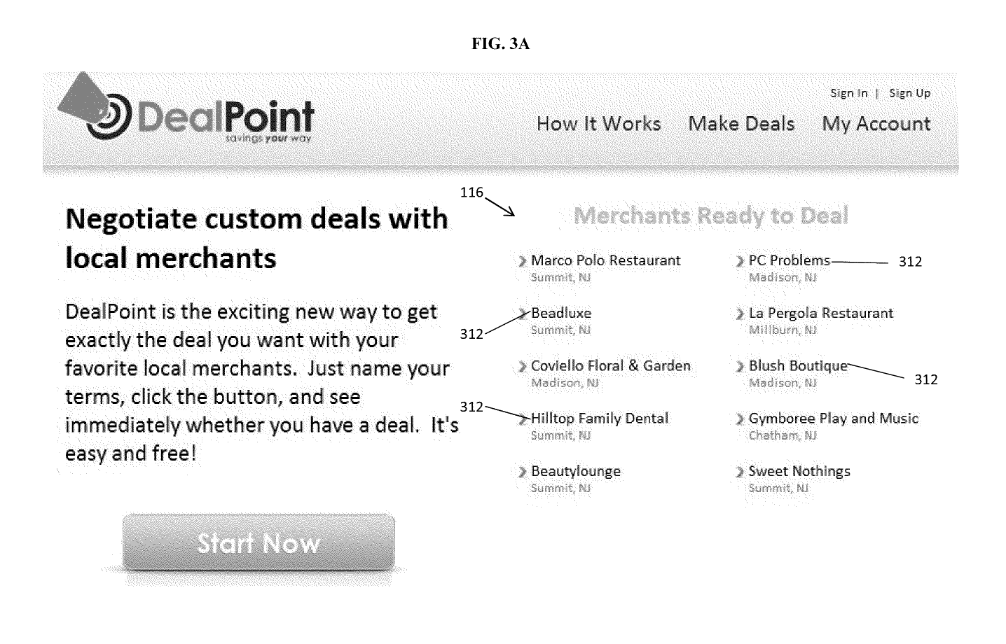

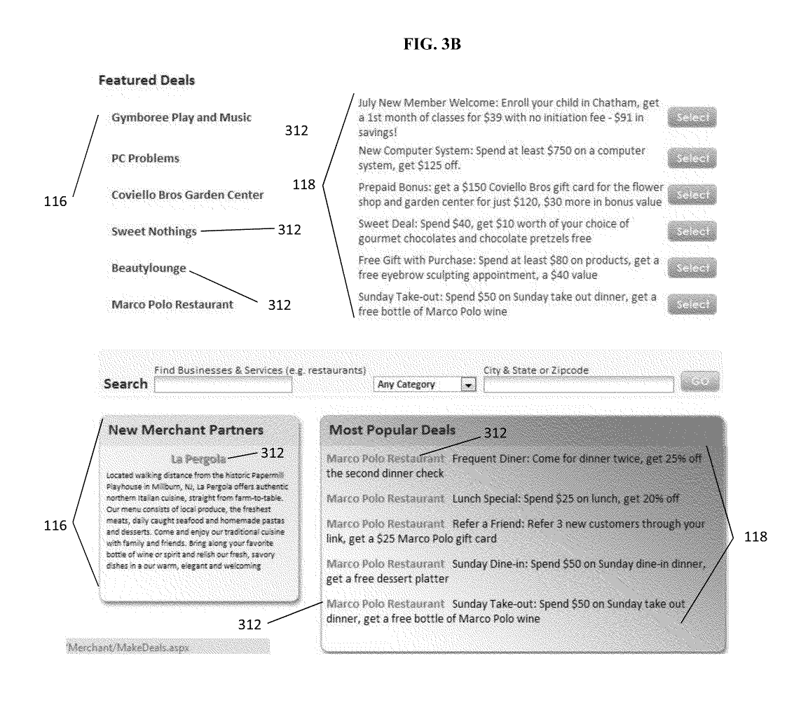

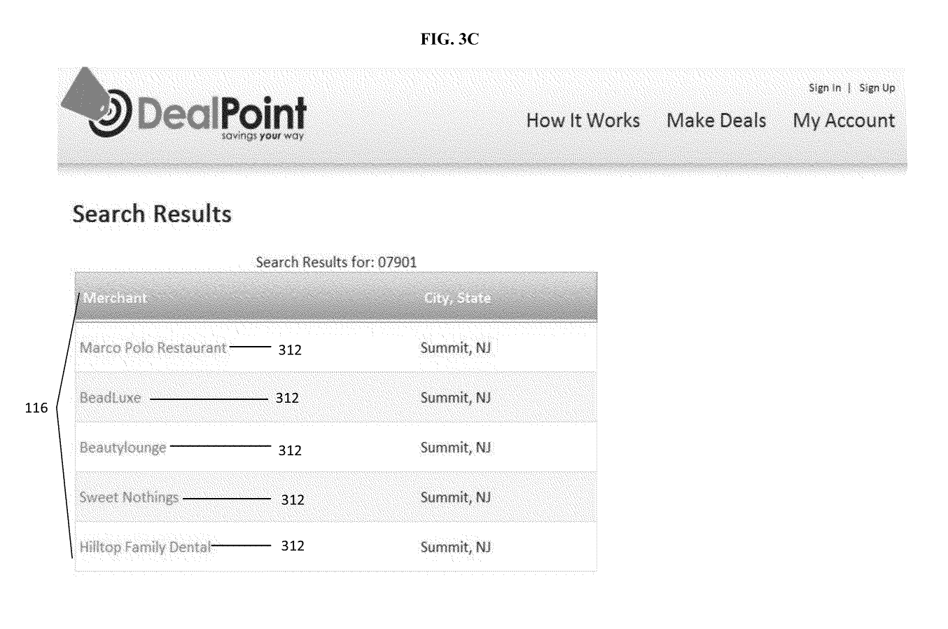

Referring first to FIG. 1, a block diagram showing the features of negotiation tool and software product 110 of the present invention are provided. Negotiation tool/software product 110 includes business presentation feature/software code 116, which lists at least one participating business and includes deal term presentation feature 118 for each of the listed businesses. Hereinafter, “feature/software code” will be abbreviated “F/S.” Deal term presentation F/S 118 presents at least one deal term offered by the listed business. Different manners of getting to the at least one deal term are illustrated below in FIGS. 3A-3C. At least one of the deal terms presented by deal term presentation F/S 118 is negotiable. Deal term presentation F/S 118 presents the deal terms either as a list of all possible deal terms 119 or as discrete preset deals 121. Preset deals 121 are at least one set of deal terms at least one of which is negotiable. With preset deals 121, deal term presentation F/S 118 allows the consumer to choose to accept a preset deal 121 with consumer preset deal acceptance F/S 120, or to customize a preset deal 121 with customization F/S 222, described in detail below with reference to FIG. 2. If the consumer chooses to accept the preset deal 121 with consumer preset deal acceptance F/S 120, a deal record 160 is created. Deal record 160 should include the accepted deal terms of the set and basic information on the business so that the consumer knows how to redeem the deal. Deal record 160 may also include information on the consumer so that the business can confirm that the right person is redeeming the deal. As an example of deal term presentation F/S 118 with preset deals 121, the business may have approved five preset deals 121 to be presented to the consumer, where each preset deal 121 includes four deal terms. All deal terms 119 includes a list of all deal terms, at least one of which is negotiable, on which a business has indicated a willingness to consider as part of a deal. With all deal terms 119 listed, the consumer must engage in some customization using customization F/S 222, by selecting which deal terms to include in his or her set, as well as what deal term options to include if the chosen deal terms include options. As an example of deal term presentation F/S 118 using all deal terms 119, the consumer may be presented with all twenty deal terms included within the five preset deals described with reference to preset deals 121 above, but it is up to the consumer to select which deal terms will be included within the set, as well as any options available for each selected deal term.

Reporting F/S 132 reports on the acceptability 134 or non-acceptability 136 of a set suggested by a consumer using customization F/S 222. If a set is deemed acceptable 134, acceptable options F/S 150 gives the consumer the options to accept that set 152 that was deemed acceptable, or customize that set 154. If the consumer accepts the set 152, deal record 160 is created. Deal record 160 should include the accepted deal terms of the set and basic information on the business so that the consumer knows how to redeem the deal. Deal record 160 may also include information on the consumer so that the business can confirm that the right person is redeeming the deal. If the consumer chooses to customize the set 154, the deal terms will be displayed as in the accepted set, and the consumer may customize them from those positions using customization F/S 222 again. If a set is deemed non-acceptable 136, non-acceptable options F/S 156 gives the consumer the option to “Reset To Original” or “Customize It!” If the consumer chooses to “Reset To Original,” then the deal terms will be displayed as in the original preset deal, and the consumer may customize them again from those positions using customization F/S 222. If the consumer chooses to “Customize It!,” then the deal terms will be displayed as in the non-accepted set, and the consumer may customize them from those positions using customization F/S/ 222 again. As both the “Reset To Original” option and the “Customize It!” option both entail the use of customization F/S 222, FIG. 1 simply shows an arrow leading from non-acceptable options F/S 156 to customization F/S 222.

Business account F/S 162 and consumer account F/S 164 allow for merchant and consumer accounts, respectively. Business account F/S 162 incorporates all features displayed in the user interface and behind the scenes of negotiation tool/software product 110 pertaining to a business being listed and qualified to negotiate deals through negotiation tool/software product 110, including input of basic business listing information, creation and input of all deal terms and preset deals into a database, as well as business deal tracking F/S 168. Business deal tracking F/S 168 tracks aspects of negotiation tool/software product 110, such as what sets consumers suggest, what sets consumers accept, what sets consumers print out, what sets are actually redeemed, time between set creation and redemption, etc . . . Deal records 160 created by consumer preset deal acceptance F/S 120 or accept set F/S 152 may be printed out using printing F/S 166 and then redeemed 170 with a business. Deal records 160, printing 166, and redemption 170 are all tracked by business deal tracking F/S 168 and stored by business account F/S 162. Deal records 160, printing 166, and redemption 170 are also all information stored by consumer account F/S 164.

FIG. 1 also shows special offer F/S 172. Special offer F/S 172 allows a business to present a special offer or special deal terms to a subset of consumers based on business criteria. Special offer F/S 172 allows a business to identify a type of consumer based on predefined parameters, such as demographic, behavioral, and historical, and provide a unique offer or deal term to such consumers, where that unique offer or deal term is not offered to all consumers that are not of that specific type. Special offer F/S 172 originates from business account F/S 162 and affects deal term presentation F/S 118, in that it provides additional or different deal terms to certain consumers. Special offer F/S 172 may be used by a business to promote its specific goals. If a restaurant wishes to revamp its menu to be more kid friendly, for example, it may identify all consumers in a certain zip code that have children or that have chosen sets in the past that include deal terms having to do with kids meals. Using special offer F/S 172, the restaurant could include a “free kids meal” deal term through the deal term presentation F/S 118 for those consumers that fit that criteria only. Alternatively, a business could use special offer F/S 172 to advantage a more desirable subset of consumers. Using special offer F/S 172, the business could identify consumers with certain qualifications, and provide them with an enhanced or additional deal term. For example, a restaurant might identify consumers who redeemed two deals in the last month; redeemed a deal with another restaurant in the last three months; and live in a specific zip code, and include a deal term for these consumers of 10% off a meal, where other consumers are not presented with such a deal term. Alternatively, a business may lower their threshold of acceptability of a set for consumers fitting certain criteria: As described above, the decision on whether a set is acceptable is determined by a comparison of give and get scores—the business may allow acceptance with a greater get score or a lower give score to consumers fitting the desired criteria.

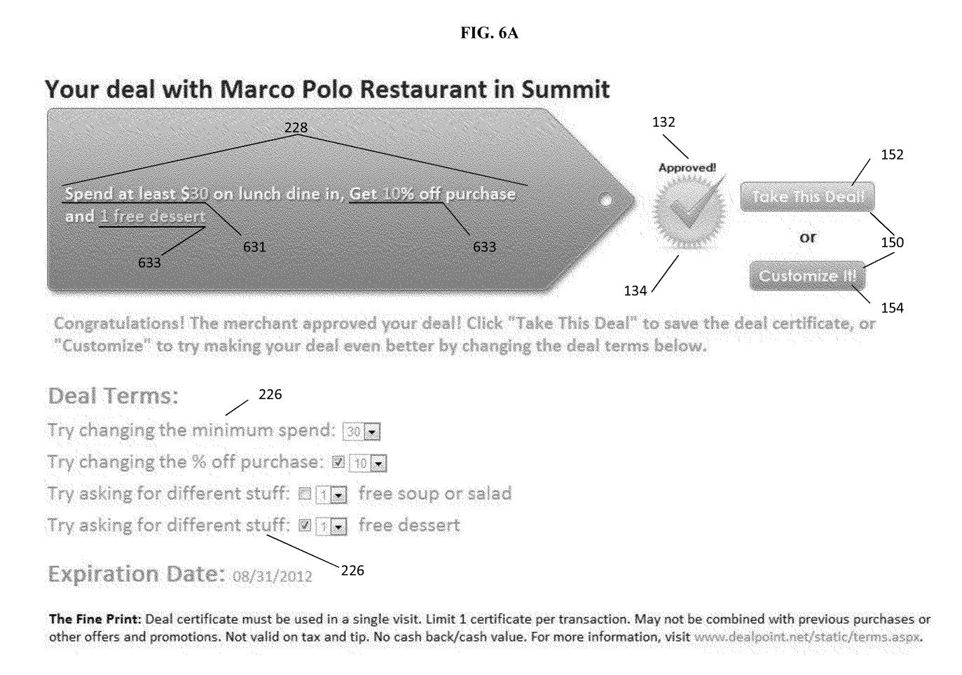

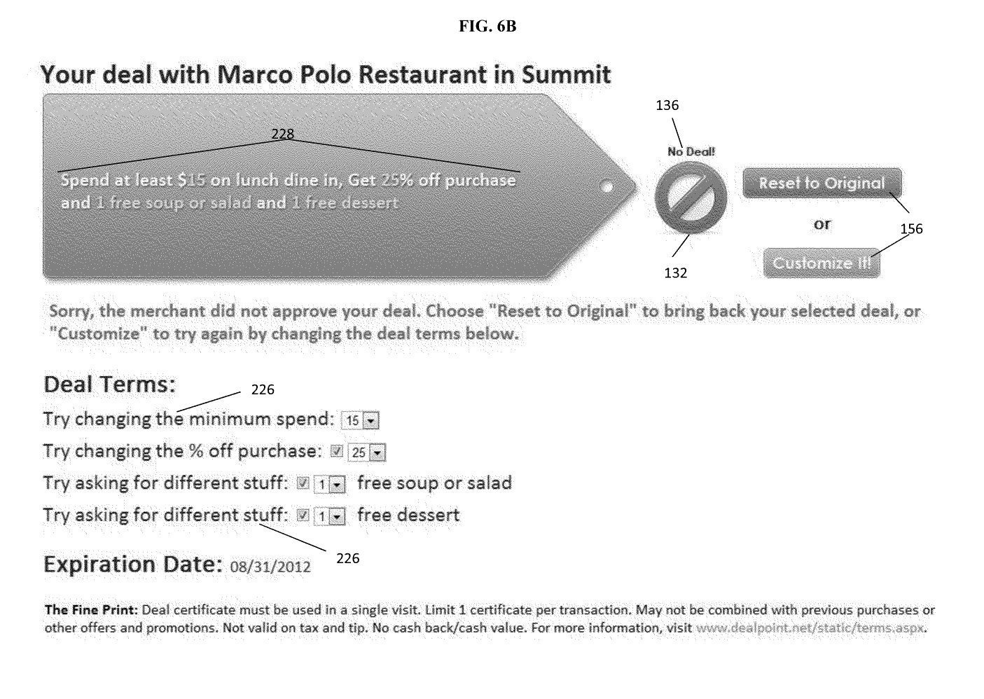

Now referring to FIG. 2, a block diagram detailing the features of customization F/S 222 is provided. Customization F/S 222 includes valuation F/S 280, suggestion F/S 224 and decision-algorithm F/S 230. Valuation F/S 280 assigns values 252 to each potential deal term and deal term option so that each possible deal term/option presented to the consumer has already been assigned a value. These values will be used in decision-algorithm F/S 230 to determine whether a consumer suggested set 228 of deal terms is acceptable or not, as described below. Valuation F/S 280 therefore assigns values 252 to both non-negotiable deal terms and negotiable deal terms, as well as to each option within a negotiable deal term if the negotiable deal term includes options. A negotiable deal term with options, for example, such as a 10%, 20%, or 30% off of a sweater, will be valuated by valuation F/S 280 as three different deal terms with different valuations for each. Therefore, every possible deal term/option is assigned a value 252, although only a subset of these deal terms will be included within a single deal. The various deal terms may be “gives” 631 or “gets” 633, as shown underlined in FIG. 6A. Gives 631 are options the consumer is willing to give within the deal, or the benefit the business gets from the deal. Gets 633 are options the consumer wants to receive within the deal, or the sacrifice the business must make from the deal. Valuation F/S 280 determines which deal terms are gives 631 and which deal terms are gets 633. Valuation may be achieved by assigning a number to a deal term or option, but may also be achieved by using relative priority of the deal terms/options and/or desirability scales of the deal terms/options. One of ordinary skill in the art will recognize that there are several ways that deal terms and options may be valuated and each of these ways is contemplated as being within the scope of the present invention.

Valuation F/S 280 assigns values 252 to deal terms and deal term options that may be inherently numeric 247 or non-inherently numeric 248. Deal terms or options that are inherently numeric 247, and therefore fairly easy to valuate, include options such as price, percent discounts, or free items. Deal terms or options that are non-inherently numeric 248, and therefore not as easily valuated, include repeat customer business, new customer referrals, or reserving the best table at a restaurant. In addition, the valuation feature utilizes business-specific valuations 249. Business-specific valuations 249 may skew the valuation of a specific deal term or option based on the business's specific goals in presenting the deal, whether the term is inherently numeric 247 or non-inherently numeric 248. Business-specific valuations 249 are based on the concept that the value of one deal term may be greater for one business than another. The value of referring a new customer might be different for a low-end family restaurant than for a high-end car dealership where the average order value and lifetime value of a customer are significantly different. Business-specific valuations 249 are therefore not assigned on a category basis, such as restaurants versus car dealerships, but on an individual business's ascribed value. Moreover, two low-end family restaurants might have different values assigned and different rewards available for referring customers if one restaurant just opened and highly values any word of mouth referrals and is very willing to provide attractive incentives to customers to do so, whereas the other restaurant may have a fifty year operating history and have a large base of loyal customers and not value the new referral as highly. For a first example of a business-specific valuation 249, if a business is very eager to drum up more patronage on Sundays, for example, a deal term that the deal occurs on Sundays may have a valuation of a greater magnitude than a deal term that the deal occurs on Tuesdays. This is an example of a deal term that is both business-specific 249 in that it refers to the individual business's goal of drumming up Sunday business, and non-inherently numeric 248 in that the day on which a deal occurs is not easily associated with a value. For a second example of a business-specific valuation 249, if a business has accidentally ordered too many of widget B and wants to get them off their shelves, a deal term offering a discounted widget B may have a valuation of a greater magnitude than a deal term that offers a discounted widget A. This is an example of a deal term that is both business-specific 249 in that it refers to the individual business's goal of selling more widget Bs, and inherently numeric 247 in that the discount on widget B is directly linked to cost—a number.

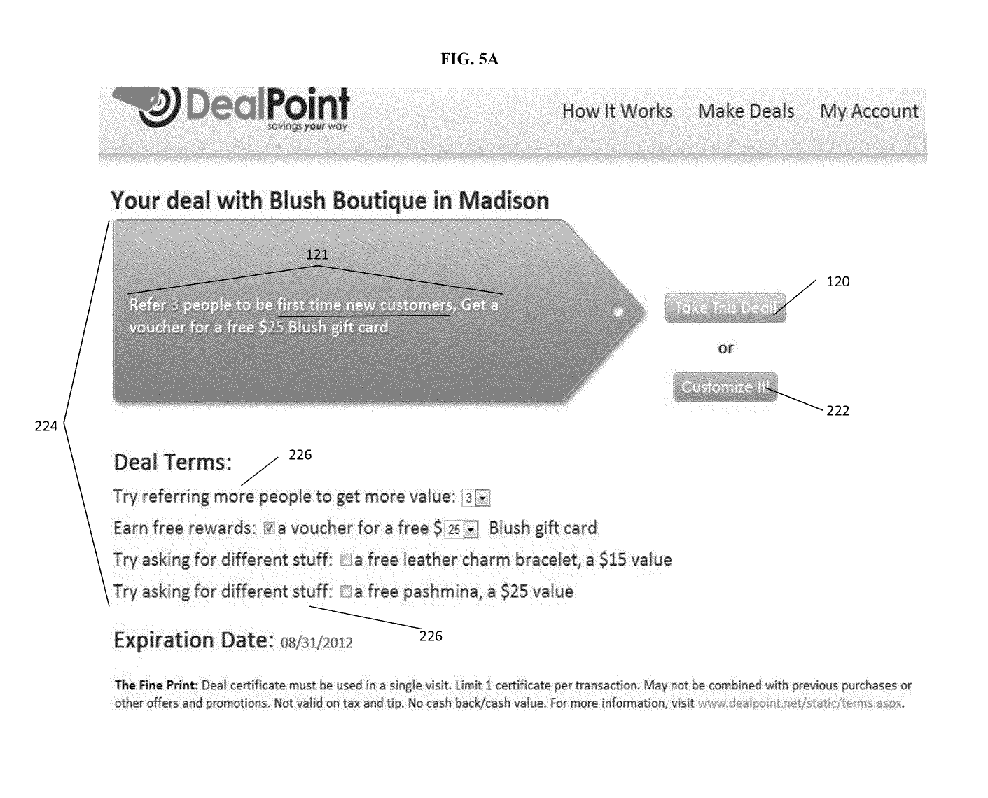

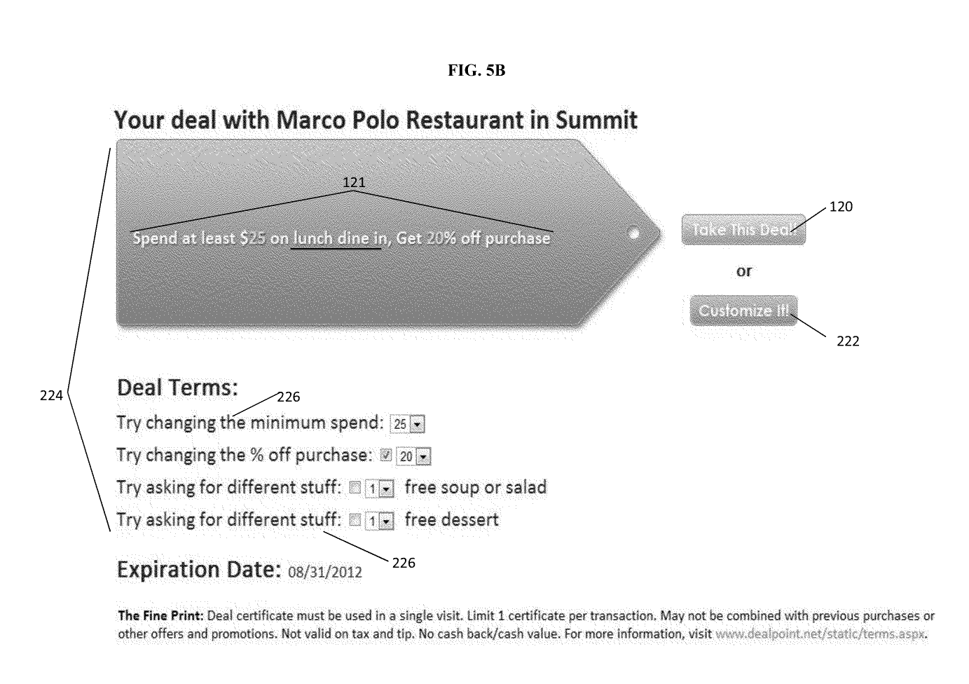

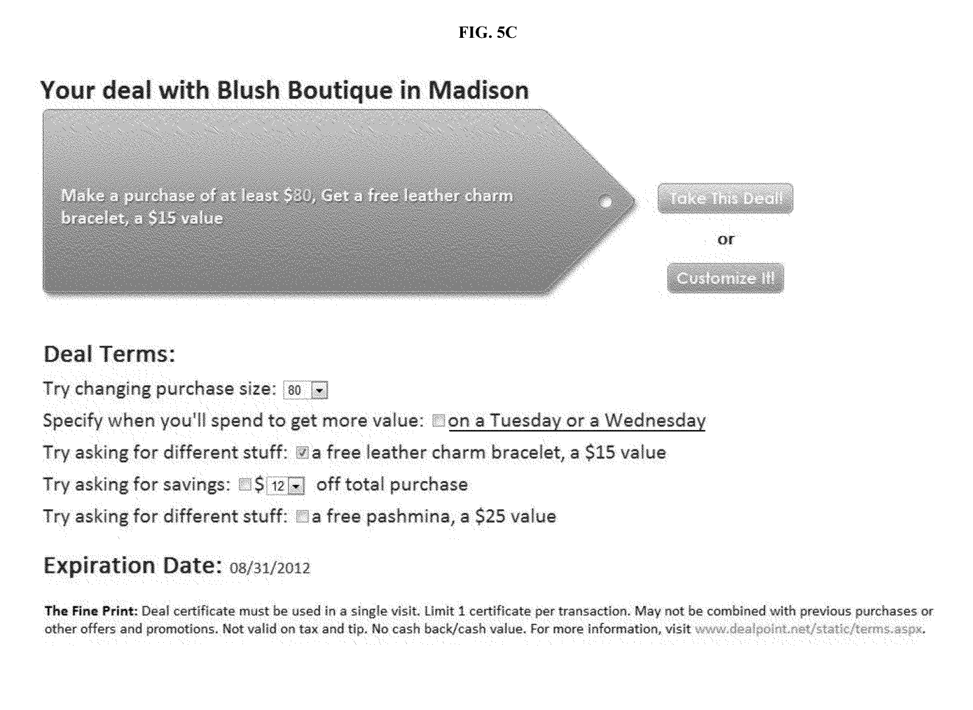

Suggestion F/S 224 allows the consumer to suggest a set 228 of deal terms. Suggestion F/S 224 presents at least one deal term 226 over which the business has previously indicated a willingness to negotiate. A deal term may be set and required as presented by the business as part of an acceptable set of deal terms, and thus non-negotiable. A deal term may also be negotiable. At least one deal term in a set of deal terms is negotiable. For a “Sunday dine-in deal,” for example, the deal terms that the deal is for a Sunday and for dine-in only may be non-negotiable by the business, but other deal terms, such as percent discount on the meal may be negotiable. A negotiable deal term may include selectable options, which may be displayed in a number of ways, as described below. Whether or not a deal term is negotiable will affect how it is displayed within customization F/S 222, as illustrated in FIGS. 5A and 5B and discussed below with reference to those FIGS. As described above, valuation F/S 280 assigns values to all possible deal terms, including non-negotiable deal terms, negotiable deal terms, and any options associated with a negotiable deal term.

A negotiable deal term may be presented with a dropdown menu with options for the deal term, such as a 20%, 30%, or 40% discount. A negotiable deal term may be presented with a selectable box, such as clicking a box to include a free dessert in the deal. A negotiable deal term may be presented as selectable as to whether or not to include that deal term at all. A negotiable deal term may be presented by a box in which the consumer may input a term, such as entering a “2” in front of “free desserts.” A negotiable deal term may be presented as some combination of these or in a different manner than those discussed above. One of ordinary skill in the art will recognize that there are many ways in which negotiable deal terms and options within a negotiable deal term may be presented, and each of these are contemplated as being within the scope of the present invention.

Decision-algorithm F/S 230 determines whether consumer-suggested set 228 of deal terms is acceptable. Each of the deal terms/options included in a set 228 has been assigned a value by valuation F/S 280. Decision-algorithm F/S 230 applies these values to an algorithm and makes the determination as to whether or not the consumer-suggested set 228 is acceptable. Decision-algorithm F/S 230 will not find a consumer-suggested set 228 acceptable unless set 228 of deal terms includes at least one give 631 and at least one get 633, as determined by valuation F/S 280. The preferred algorithm scores 240 gives 631 of set 228 by combining the values of gives 631 of set 228. It also scores 242 gets 633 of set 228 by combining the values of gets 633 of set 228. The combining may be by addition of the values or by other manipulation, such as in the case where the values are not necessarily numbers, but priorities, for example. The algorithm compares 244 the give and get scores 240, 242 to determine acceptability 246 of set 228.

Now referring to FIGS. 3A-3C, sample screenshots illustrating different versions of business presentation F/S 116 are provided. FIG. 3A shows businesses 312 listed under “Merchants Ready to Deal.” These businesses 312 may pay extra to be so presented or may be selected to be so presented by some other criteria, for example as a bonus to the business for initiating and completing a business account with negotiation tool/software product 110. FIG. 3B shows businesses 312 listed under “Featured Deals,” “New Merchant Partners,” and “Most Popular Deals.” Again, various criteria may merit the inclusion of a business 312 in such a presentation. Under “Featured Deals” and “ Most Popular Deals” we also see examples of deal term presentation F/S 118, with deal terms presented next to businesses 312 offering them. FIG. 3C shows businesses 312 listed as for the product of a search (not shown) of businesses within zip code 07901. FIGS. 3A-3C are but a few examples of how business presentation F/S 116 may present businesses 312 to consumers.

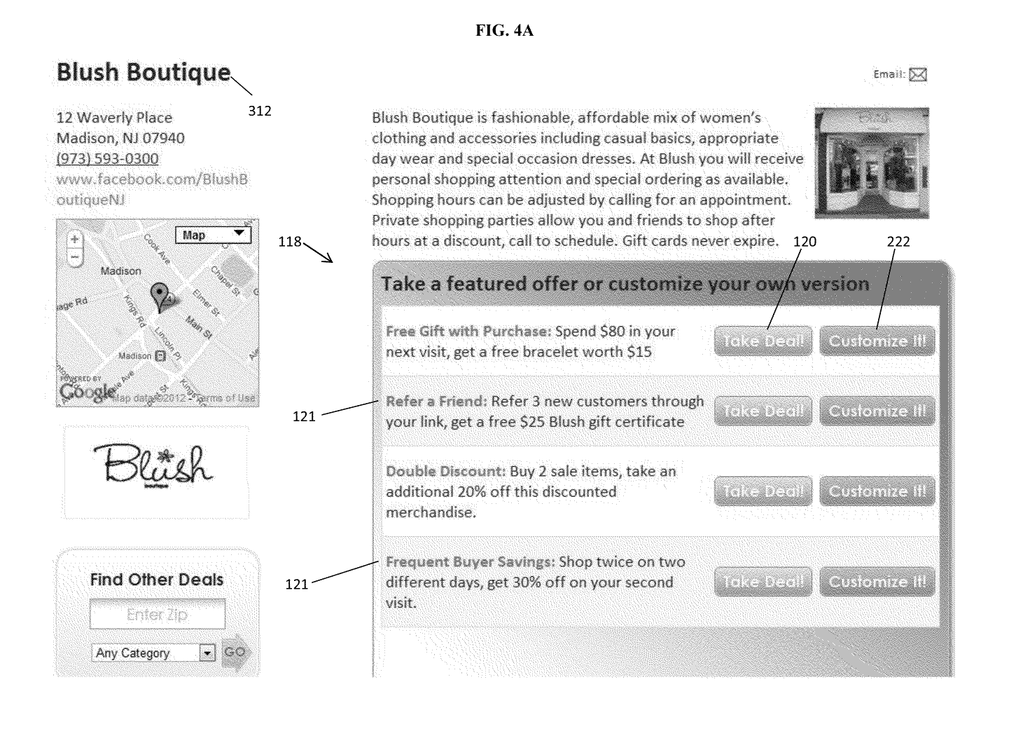

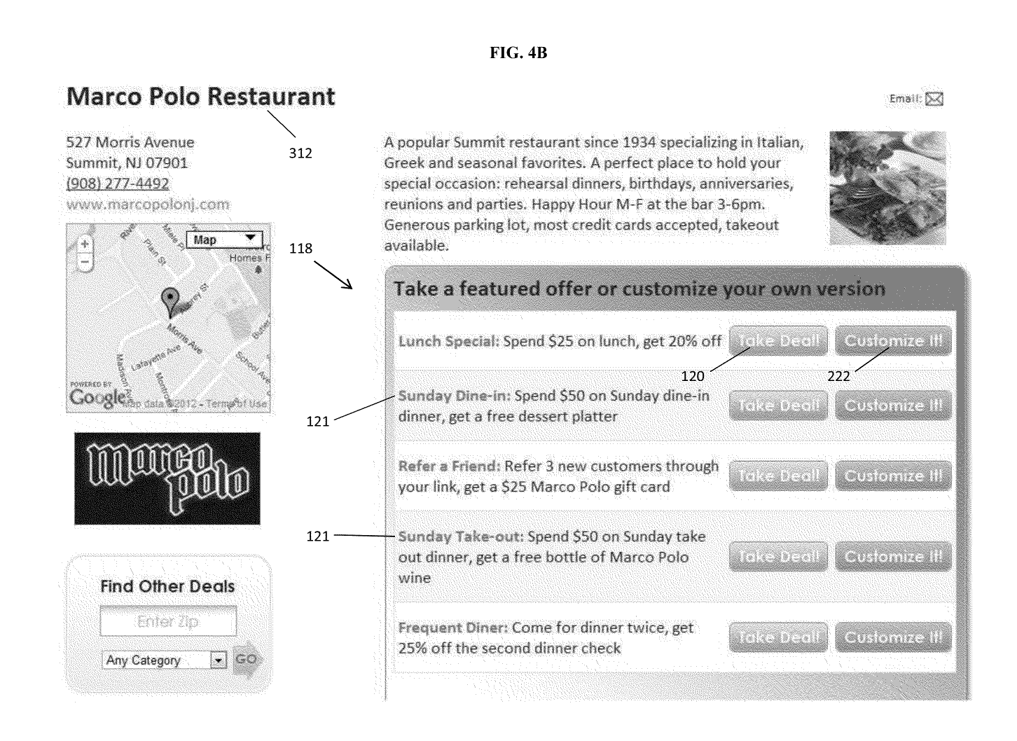

Now referring to FIGS. 4A and 4B, sample screenshots illustrating deal term presentation F/S 118 for two businesses 312 are shown. FIGS. 4A and 4B show the preferred deal term presentation F/S 118 that includes a number of preset deals 121 including several deal terms each rather than listing all possible deal terms 119. For each preset deal 121, the consumer has the option to use consumer preset deal acceptance F/S 120 to accept the deal or customization F/S 222 to customize the deal. If consumer preset deal acceptance F/S 120 is used, a deal record 160 of set 228 is created and stored in both the consumer and business accounts. Deal record 160 may be printed 166 and redeemed 170. Printing 166 and redemption 170 are also stored in both the consumer and business accounts.

FIGS. 5A-5C, sample screenshots illustrating suggestion F/S 224 for two businesses 312 are provided. Preset deal 121 that the consumer chose to customize is initially listed in the shaded box near the top of the FIGS. Deal terms are presented 226 below, including options presented in dropdown menus or with selectable boxes. In FIG. 5A, for example, the deal term “Try referring more people to get more value,” includes a dropdown menu so that the consumer may select 1, 2, or 3 referrals. Note that this particular deal term of referring more people is not necessarily easily valuated. The number of people referred is inherently numeric 247, as shown in FIG. 2, but the act of referring someone itself is not specifically connected to a number or value—it is non-inherently numeric 248. Valuation F/S 280, shown in FIG. 2 would assign a value to this deal term despite its inclusion of both inherently numeric 247 and non-inherently numeric 248 attributes. In FIG. 5B, for example, there are two deal terms stating, “Try asking for different stuff.” These deal terms are both selectable as far being included in the set by a selectable box, and selectable as far as quantity of “stuff”—soup or salad or dessert. As the consumer makes selections from the dropdown boxes or by selecting a box, i.e. as the consumer makes his or her set 228, the terms in the shaded box will change to reflect the consumer's set 228. It is notable that non-negotiable terms, which the consumer cannot change and the business requires to be part of the deal are always included in the shaded box. In FIG. 5A, the underlined term requiring that the referrals be “first time new customers” is non-negotiable. In FIG. 5B, the underlined terms requiring that the meal is “lunch dine in” are non-negotiable. The deal terms “on a Tuesday or Wednesday” are underlined in FIG. 5C. This highlights the use of a deal term that may be assigned a value 252 by valuation F/S 280 based on business-specific criteria 249, which is an example of non-inherently numeric criteria 248. Business-specific criteria 249 reflects specific goals of a business 312. In this case, business 312 probably has very slow business on Tuesdays and Wednesdays and offers this deal term to try to encourage business on those days. That goal of encouraging business on specific days is business-specific 249 and non-inherently numeric 248.

Now referring to FIGS. 6A and 6B, sample screenshots illustrating acceptability and non-acceptability 134, 136, respectively, are provided. In both FIGS., the shaded box at the top nowshows customer-suggested set 228. In FIG. 6A, this set 228 has been accepted. In FIG. 6B, this set 228 has not been accepted. Neither decision-algorithm F/S 230, nor valuation F/S 280, is shown in these FIGS., and is, in fact, not visible to the consumer. Regardless, we know that valuation F/S 280 assigned values to each potential deal term before the consumer used suggestion F/S 224, and decision-algorithm F/S 230 applied the values 238 of the consumer-suggested set 228 to an algorithm, and determined acceptability 134 of set 228 in FIG. 6A, and the non-acceptability 136 of set 228 in FIG. 6B. The FIGS. also illustrate reporting F/S 132 reporting that decision-algorithm F/S 230 determined acceptability 134 set 228 in FIG. 6A, and non-acceptability 136 of set 228 in FIG. 6B.

In FIG. 6A, acceptable options F/S 150 has provided the options of using accept set F/S 152 or customize set F/S 154. If accept set F/S 152 is used, a deal record 160 of set 228 is created and stored in both the consumer and business accounts. Deal record 160 may be printed 166 and redeemed 170. Printing 166 and redemption 170 are also stored in both the consumer and business accounts. If customize set F/S 154 is used, the consumer will have the option to further customize accepted set 228: The consumer will be invited to use suggestion F/S 224 on a screen similar to those shown in FIGS. 5A and 5B, except that the shaded box will include accepted set 228 and deal term presentation F/S 226 will initially present the deal terms as they were in accepted set 228. FIG. 6A also presents an illustration of gives 631 and gets 633. Accepted set 228 is shown in the shaded box at the top. “Spend at least $30” is underlined and labeled as an example of a give 631, or something the consumer is willing to give in the deal. “Get 10% off purchase” and “1 free dessert” are underlined and labeled as an example of a get 633, or something the consumer will get in the deal.

In FIG. 6B, non-acceptable options F/S 156 provide the options of “Reset to Original” or “Customize It!” If the consumer chooses to “Reset To Original,” then consumer will be invited to use suggestion F/S 224 on a screen similar to those shown in FIGS. 5A and 5B, with the shaded box and deal terms displaying the original preset deal 121, and the consumer may customize them again from those positions. If the consumer chooses to “Customize It!,” then the consumer will be invited to use suggestion F/S 224 on a screen similar to those shown in FIGS. 5A and 5B, but with the shaded box and deal terms displaying the deal terms of non-accepted set 228, and the consumer may customize them from those positions. Therefore both the “Reset To Original” option and the “Customize It” option both entail the use of the customization F/S 222 again.

Although the present invention has been described in considerable detail with reference to certain preferred versions thereof, other versions would be readily apparent to those of ordinary skill in the art. Therefore, the spirit and scope of the description should not be limited to the description of the preferred versions contained herein.

We claim:

1. A negotiation tool for facilitating online, automated negotiation between a consumer and a business, comprising:
a business presentation feature that lists at least one business and comprises a deal term presentation feature for each of the at least one listed business, wherein:
said deal term presentation feature presents at least one deal term offered by the at least one listed business, wherein at least one of the at least one deal terms is negotiable;
a customization feature that allows for customizing the at least one deal term, said customization feature comprising:
a valuation feature that assigns values to each of the at least one deal terms;
a suggestion feature that allows the consumer to suggest a set of deal terms selected from the at least one deal term; and
a decision-algorithm feature that makes a decision on behalf of the business concerning an acceptability of the consumer-suggested set; and
a reporting feature that reports to the consumer said acceptability of the consumer-suggested set, wherein said acceptability is selected from the group consisting of acceptable and non-acceptable.

2. The negotiation tool as claimed in claim 1, wherein said deal term presentation feature presents the at least one deal term within a list of at least one preset deal, each of the at least one preset deals comprising at least one negotiable deal term, and said negotiation tool further comprises a consumer preset deal acceptance feature that allows the consumer to accept one of the at least one preset deals.

3. The negotiation tool as claimed in claim 1, wherein said decision-algorithm feature of said customization feature applies said values assigned by said valuation feature to an algorithm and determines said acceptability of the consumer-suggested set based on a result of said algorithm with said values.

4. The negotiation tool as claimed in claim 3, wherein each of the at least one deal terms assigned a value by said valuation feature is one of a group selected from a give and a get, and wherein said decision-algorithm feature of said customization feature determines said acceptability of the consumer-suggested set by scoring said gives, scoring said gets, and comparing said gives score and said gets score.

5. The negotiation tool as claimed in claim 1, wherein said valuation feature assigns values to the at least one deal terms comprising deal terms that are inherently numeric and deal terms that are non-inherently numeric.

6. The negotiation tool as claimed in claim 1, wherein said valuation feature assigns values to the at least one deal terms whose value is business-specific.

7. The negotiation tool as claimed in claim 1, wherein said reporting feature comprises:
an acceptable options feature usable if the consumer-suggested set is acceptable and that gives the consumer options to:
accept the consumer-suggested set and create a record of the consumer-suggested set that is shared with the consumer and the business; and
customize the consumer-suggested set using said customization feature; and
a non-acceptable option feature usable if the consumer-suggested set is non-acceptable and that gives the consumer an option to use said customization feature again.

8. The negotiation tool as claimed in claim 1, further comprising:
a business account feature that allows businesses to provide information to said negotiation tool, wherein said negotiation tool stores the business-provided information and a history of a use of said negotiation tool by the business; and
a consumer account feature that allows consumers to provide information to said negotiation tool, wherein said negotiation tool stores the consumer-provided information and a history of a use of said negotiation tool by the consumer.

9. The negotiation tool as claimed in claim 8, wherein said business account feature comprises a business deal tracking feature that provides information to businesses concerning consumer usage of said negotiation tool.

10. The negotiation tool as claimed in claim 8, further comprising a special offer feature that allows businesses to present additional deal terms to consumers meeting business specified criteria through said deal term presentation feature.

11. The negotiation tool as claimed in claim 2, further comprising a printing feature that allows the consumer to print one of a group consisting of a record of the accepted preset deal terms if the consumer uses said consumer preset deal acceptance feature and a record of the consumer-suggested set and said acceptability of the consumer-suggested set if the consumer-suggested set is acceptable if the consumer uses said customization feature.

12. A negotiation software product for facilitating online, automated negotiation between a consumer and a business, storable on a computer readable medium and executable by a server, comprising:
business presentation software code that lists at least one business and comprises deal term presentation software code for each of the at least one listed business, wherein:
said deal term presentation software code presents at least one deal term offered by the at least one listed business, wherein at least one of the at least one deal terms is negotiable;
customization software code that allows for customizing the at least one deal term, said customization software code comprising:
valuation software code that assigns values to each of the at least one deal terms;
suggestion software code that allows the consumer to suggest a set of deal terms selected from the at least one deal term; and
decision-algorithm software code that makes a decision on behalf of the business concerning an acceptability of the consumer-suggested set; and
reporting software code that reports to the consumer said acceptability of the consumer-suggested set, wherein said acceptability is selected from the group consisting of acceptable and non-acceptable.

13. The negotiation software product as claimed in claim 12, wherein said deal term presentation software code presents the at least one deal term within a list of at least one preset deal, each of the at least one preset deals comprising at least one negotiable deal term, and said negotiation software product further comprises consumer preset deal acceptance software code that allows the consumer to accept one of the at least one preset deals.

14. The negotiation software product as claimed in claim 12, wherein said decision-algorithm software code of said customization software code applies said values assigned by said valuation software code to an algorithm and determines said acceptability of the consumer-suggested set based on a result of said algorithm with said values.

15. The negotiation software product as claimed in claim 14, wherein each of the at least one deal terms assigned a value by said valuation software code is one of a group selected from a give and a get, and wherein said decision-algorithm software code of said customization software code determines said acceptability of the consumer-suggested set by scoring said gives, scoring said gets, and comparing said gives score and said gets score.

16. The negotiation software product as claimed in claim 12, wherein said valuation software code assigns values to the at least one deal terms comprising deal terms that are inherently numeric and deal terms that are non-inherently numeric.

17. The negotiation software product as claimed in claim 12, wherein said valuation software product assigns values to the at least one deal terms whose value is business-specific.

18. The negotiation software product as claimed in claim 12, wherein said reporting software code comprises:
acceptable options software code executable if the consumer-suggested set is acceptable and that gives the consumer options to:
accept the consumer-suggested set and create a record of the consumer-suggested set that is shared with the consumer and the business; and
customize the consumer-suggested set by executing said customization software code; and
non-acceptable option software code executable if the consumer-suggested set is non-acceptable and that gives the consumer an option to execute said customization software code again.

19. The negotiation software product as claimed in claim 12, further comprising:
business account software code that allows businesses to provide information to said negotiation software product, wherein said negotiation software product stores the business-provided information and a history of a use of said negotiation software product by the business; and
consumer account software product that allows consumers to provide information to said negotiation software product, wherein said negotiation software product stores the consumer-provided information and a history of a use of said negotiation software product by the consumer.

20. The negotiation software product as claimed in claim 19, wherein said business account software code comprises business deal tracking software code that provides information to businesses concerning consumer usage of said negotiation tool.

21. The negotiation software product as claimed in claim 19, further comprising special offer software code that allows businesses to present additional deal terms to consumers meeting business specified criteria through said deal term presentation software code.

22. The negotiation software product as claimed in claim 13, further comprising printing software code that allows the consumer to print one of a group consisting of a record of the accepted preset deal terms if the consumer executes said consumer preset deal acceptance software code and a record of the consumer-suggested set and said acceptability of the consumer-suggested set if the consumer-suggested set is acceptable if the consumer executes said customization software code.

23. A customization tool for online, automated negotiation between a consumer and a business, comprising:
a valuation feature that assigns values to each of at least one business-provided deal term, wherein at least one of the at least one business-provided deal terms is negotiable;
a suggestion feature that allows the consumer to suggest a set of deal terms selected from the at least one business-provided deal term; and
a decision-algorithm feature that makes a decision on behalf of the business concerning an acceptability of the consumer-suggested set.

24. The customization tool as claimed in claim 23, wherein said decision-algorithm feature applies said values assigned by said valuation feature to an algorithm and determines said acceptability of the consumer-suggested set based on a result of said algorithm with said values.

25. The customization tool as claimed in claim 24, wherein each of the at least one deal terms assigned a value by said valuation feature is one of a group selected from a give and a get, and wherein said decision-algorithm feature determines said acceptability of the consumer-suggested set by scoring said gives, scoring said gets, and comparing said gives score and said gets score.

26. The customization tool as claimed in claim 23, wherein said valuation feature assigns values to the at least one deal terms comprising deal terms that are inherently numeric and deal terms that are non-inherently numeric.

27. The customization tool as claimed in claim 23, wherein said valuation feature assigns values to the at least one deal terms whose value is business-specific.
